(19) United States
(12) Patent Application Publication
(10) Pub. No.: US 2009/0319268 A1
(43) Pub. Date: Dec. 24, 2009

(54) METHOD AND APPARATUS FOR MEASURING THE INTELLIGIBILITY OF AN AUDIO ANNOUNCEMENT DEVICE

(75) Inventors: Xavier AUMONT, Montauban (FR); Antoine WILHELM-JAUREGUIBERRY, Leguevin (FR)

Correspondence Address: YOUNG & THOMPSON, 209 Madison Street, Suite 500, Alexandria, VA, 22314, US

(73) Assignee: ARCHEAN TECHNOLOGIES, Montauban (FR)

(21) Appl. No.: 12/488,244

(22) Filed: Jun. 19, 2009

(30) Foreign Application Priority Data
Jun. 19, 2008 (FR) 08.03435

(51) Int. Cl. G10L 15/00

(52) U.S. Cl. 704/236; 704/E15.001

(57) ABSTRACT

A method and an apparatus for measuring the intelligibility level of an audio announcement device (40), employ at least one speech recognition module (418; 518) for analyzing the reconstructed verbal content of the audio message announced by the audio announcement device (40), optionally by comparison with the verbal content of an original audio message.

The invention relates to a method for measuring the intelligibility level of an audio announcement device, to an apparatus for measuring this intelligibility level, and to a storage medium for carrying out the method by means of a data-processing device such as a personal computer.

It is common to use audio announcement devices to announce a voice message for information or warning to one or more individuals, in a wide variety of forms or environments. Examples which may be mentioned are public address devices of buildings or those encountered in means of transportation (airplane, train, etc.) and also those used in the open air during fairs or equivalent events. However, audio announcement devices are also meant to include other devices using electro-acoustic transducers to transmit a voice message, such as telephones or the like, hearing aid apparatus or voice guidance apparatus.

In order to ensure that the device is fit for its purpose, it is necessary to check whether a message announced by the device is intelligible, i.e. can be understood, under numerous listening conditions and in widely varying working environments of the device, for example ambient noise, sound reverberations, etc.

There are two types of methods for evaluating the intelligibility level of an audio announcement device:
So-called objective methods such as those described in document US 2005/0135637, which use standardized processes in which a reference audio signal (for example white noise or pink noise) is amplitude-modulated with different modulation factors and frequencies, this signal is output by at least one loudspeaker of the audio announcement device to be measured, then recorded by a microphone and analyzed by comparing for example the modulation depth in the various frequency bands between the original signal and the signal announced and recorded. Although they offer the advantage of giving reproducible measurements, these methods do not use messages having a verbal content and are only an approximation to the desired goal of evaluating the capability of the announced message to be understood.
So-called subjective methods, which aim to overcome this drawback by employing a panel of listeners who are meant to evaluate the intelligibility of the device as they perceive it. To this end, standardized methods provide lists of words (phonetically balanced word list method) or texts (modified rhyme test method) which are announced to the panel of listeners by the device to be measured. In order to avoid too much subjectivity in these judgments, however, multiple tests should be carried out while alternating the listeners and the announced messages, which makes the measurement time-consuming and expensive while giving a result whose reproducibility may be questionable.

It is therefore an object of the present invention to provide a method and apparatus for measuring the intelligibility level of an audio announcement device, which do not have the drawbacks of the prior art and make it possible to obtain a rapid and reproducible measurement that is representative of the capability of an announced verbal message to be understood.

To this end, the invention relates to a method for measuring the intelligibility level of an audio announcement device, comprising the following steps:
defining a verbal content of a voice message, referred to as the original verbal content,
compiling an audio message, referred to as the original audio message, on the basis of said original verbal content,
announcing said original audio message using the audio announcement device,
recording an announced audio message at the output of the announcement device,
transmitting said announced audio message to a speech recognition module adapted to reconstruct a verbal content of the announced audio message,
analyzing the verbal content of the announced audio message reconstructed by the speech recognition module, and
calculating a measure of the intelligibility level of the audio announcement device on the basis of this analysis.

In a first embodiment of the measurement method according to the invention, in association with each word recognized in the announced message, the speech recognition module is adapted to provide an estimate of the correspondence probability between said recognized word and a corresponding portion of the announced message, the analysis of the verbal content of the announced message is carried out by calculating a relevance indicator on the basis of a resultant probability over at least a significant fraction of the verbal content of the announced message, and the measure of the intelligibility level is obtained by comparing said relevance indicator with a reference table.

Advantageously, the significant fraction of the verbal content of the announced message corresponds to a message length of between 30 and 50 seconds.

In a second embodiment of the measurement method according to the invention, the analysis of the verbal content of the announced message is carried out by comparing it with the original verbal content.

According to a variant of this second embodiment, synchronization markers are inserted into the original audio message at predefined locations of the original verbal content, and the speech recognition is performed in closed loop as a function of the position of said synchronization markers in the announced audio message. The verbal content of the announced message can thus be synchronized with the original verbal content and comparison of the two can be carried out “word by word”, thus making the comparison step faster and more precise.

According to an advantageous feature of the invention, which may be applied to the first and second embodiments of the measurement method, the original message is a predetermined message and the speech recognition module is adapted by the addition of training data relating to said original message.

In a third embodiment of the measurement method according to the invention, the original message is transmitted to a second speech recognition module after the compilation step, and the analysis of the verbal content of the announced message reconstructed by the first speech recognition module is carried out by comparison with the verbal content of the original message reconstructed by the second speech recognition module.

According to an advantageous feature of the second and third embodiments, the measure of the intelligibility level is obtained by a combination of indicators selected from among a recognition rate, a substitution rate, a deletion rate and an insertion rate, each indicator being calculated for a predetermined length of the original message. More precisely, the predetermined length corresponds to a message length of between 30 and 50 seconds.

According to another feature of the measurement method according to the invention, particularly adapted for the tuning of auditory prostheses, said auditory prosthesis is used as the audio announcement device in series with a filter having a frequency response curve identical to that of an ear to be fitted with an aid, and the intelligibility level of said device is measured. Indeed, it is common that a patient whose ear needs to be fitted with an aid may complain of a lack of intelligibility even though the prosthesis has been adjusted to compensate for the deficiencies in the frequency response curve of their ear. Thus, by directly measuring the intelligibility level as it will be perceived by the patient, the prosthesis can be tuned in order to maximize this level without the need to involve the patient.

The invention also provides an apparatus for measuring the intelligibility level of an audio announcement device, comprising at a least one analog output adapted to transmit an original audio message to the audio announcement device, at least one microphone associated with a recording and digitization module adapted to record an audio message announced by said audio announcement device, at least one speech recognition module adapted to reconstruct a verbal content of the announced audio message, on the basis of the announced audio message recorded by the recording module, a calculation module adapted to analyze said verbal content and to calculate a measure of the intelligibility level of the audio announcement device, and a display adapted to visualize said measure.

Advantageously and according to the invention, the apparatus furthermore comprises a reader of storage media and/or internal memory means which is adapted to read and save files representing the original audio message, the verbal content of said message and training data of the speech recognition module.

Advantageously and according to the invention, the apparatus may also comprise a synchronization signal generator adapted to cooperate with the analog output module and to insert synchronization markers into the original audio message at predefined locations of the original verbal content. In this case, the speech recognition module is adapted to detect said markers and synchronize the reconstructed verbal content of the announced audio message with the original verbal content.

Advantageously and according to the invention, the apparatus may also comprise a module for compiling the original audio message, which cooperates with the analog output module in order to transmit an original audio message to the audio announcement device and comprises at least one of a microphone, a storage medium reader or a speech synthesis module.

Advantageously and according to the invention, the measurement apparatus comprises a second recording and digitization module as well as a second speech recognition module, which are adapted to cooperate with the analog output and to reconstruct a reconstructed verbal content of the original audio message. In this case, the calculation module is adapted to compare said reconstructed verbal content of the original audio message and a verbal content of the announced audio message, and to calculate a measure of the intelligibility level of the audio announcement device on the basis of said comparison.

The invention also includes a storage medium—particularly of the removable type (CD-ROM, DVD, USB stick, memory card etc.)—for carrying out the measurement method with the aid of a data-processing device of the personal computer type, for example. The medium contains at least a file of the audio type representing the original audio message, an associated file of the text type representing the verbal content of the original audio message and a file of training data, associated with the original audio message, for the speech recognition module. Thus, a personal computer containing an appropriate speech recognition program may simply be programmed to carry out the measurement method. Advantageously, the storage medium may also contain program instructions adapted to program a speech recognition module and to carry out the calculation of the intelligibility measure.

The invention also relates to a method and an apparatus for measuring the intelligibility of an audio announcement device, and a storage medium, comprising in combination some or all of the features mentioned above or below.

Other objects, features and advantages of the invention will become apparent in the light of the following description and the appended drawings, in which:

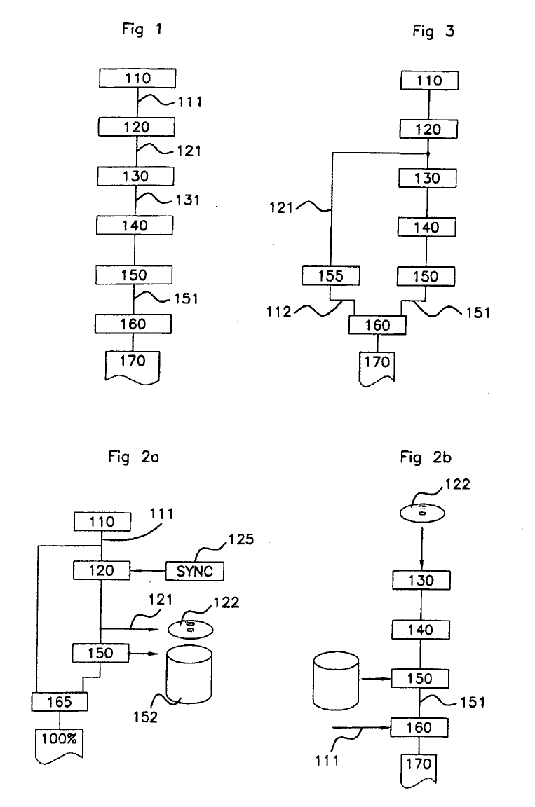

FIG. 1 represents a schematic flow chart of the steps of the method according to the invention,

FIGS. 2a and 2b schematically represent two complementary segments of the method according to a second embodiment,

FIG. 3 represents a schematic flow chart of the steps of the method according to a third embodiment,

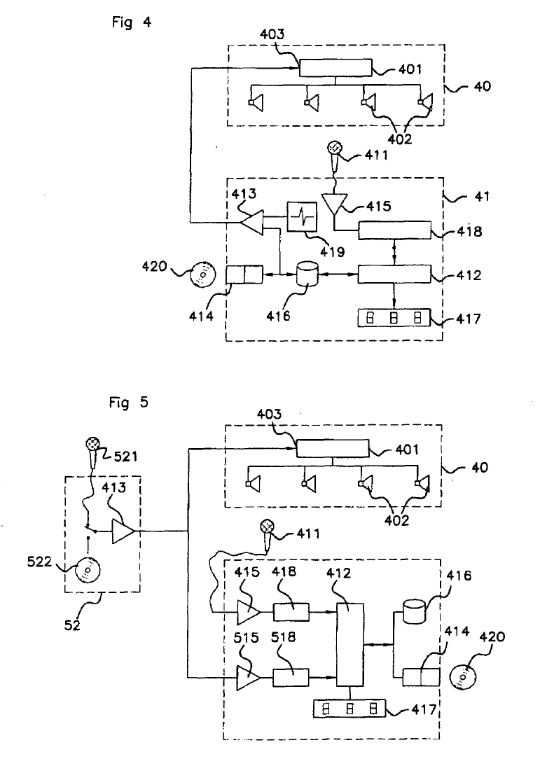

FIG. 4 schematically represents a measurement apparatus according to the invention, adapted to carry out the method according to its first or second embodiment, and

FIG. 5 schematically represents a measurement apparatus according to the invention, adapted to carry out the method according to its third embodiment

FIG. 1 represents at 110 a step of defining a verbal content of a message to be announced, referred to as the original verbal content 111. This definition may be carried out by using the various existing standards for the selection of particular words (for example according to the phonetically balanced word list method) or phrases (for example according to the modified rhyme test method), or it may be based on typical messages which are or will be announced by an audio announcement device 40 (FIG. 4) whose intelligibility is to be evaluated. This definition step is not necessarily carried out each time the method is employed. In fact, it may be sufficient to define once and for all a series of contents covering essentially all requirements, and to standardize them.

The original verbal content 111 is then transmitted to a step 120 of compiling an audio message, which will be used as an original audio message 121 for testing the audio announcement device 40. Like the previous step, this step 120 need not be carried out fully each time the method is performed. For example, a standardized original verbal content 111 may be read in a loud voice by a speaker and stored on a storage medium 122 (FIG. 2a) in the form of an analog or digital audio file. In this case, it will merely be necessary to re-play the audio file each time the method is carried out. In another variant, step 120 may be carried out on every occasion by transmitting a text file, representing the original verbal content 111, to a speech synthesis module which will compile the audio message on the basis of this file.

The original audio message 121 is then transmitted to step 130, in which it is sent to the audio announcement device 40 in order to be announced, for example in a conference theater in which the audio announcement device is intended to be measured. It is important to note that the term audio announcement should be understood in the rest of the description as including both the device which will generate the sound waves by means of electromechanical transducers, for example loudspeakers, and also the environment of the device which may comprise a theater with its possibly changing conditions of echo, reverberation and/or attenuation, or alternatively open air conditions which are subject to wind variations etc.

The announced audio message 131 may thus be distorted relative to the original audio message 121, both because of the intrinsic characteristics of the audio announcement device 40 and by the environmental conditions which prevail during this announcement.

The announced audio message 131 is then recorded in step 140, for example by means of a microphone 411 (FIG. 4) associated with a recording and digitization module such as an analog-digital converter with which an audio recording card is equipped, and converted into an audio file which is digitized, thus representing the announced audio message as faithfully as possible.

During step 150, the announced audio message is then transmitted (in this form) to a speech recognition module. Such modules are well known to the person skilled in the art, for instance the one provided by the Italian company LOQUENDO.

The principal function of a speech recognition module is to reconstruct a verbal content corresponding to an audio message, generally in the form of a text file comprising a list of words recognized by the speech recognition module and, for each word, a series of complementary information such as the timestamp of the instant when the word was recognized and an estimate of the probability that the recognized word in fact matches the corresponding portion of the audio message.

In step 150 the announced audio message 131 is analyzed by the speech recognition module, which delivers a reconstructed verbal content 151 of the announced audio message. This reconstructed verbal content 151 is then transmitted to step 160, in which it is analyzed in order to derive therefrom a measure of the intelligibility level 170 of the audio announcement device 40.

The analysis carried out in step 160 may be of two types: intrinsic or comparative.

In a first embodiment of the measurement method, the probability estimate provided for each word by the speech recognition module is used in order to derive a relevance indicator therefrom by probability combination, the indicator representing the probability that the announced audio message 131 has been “perceived” coherently by the speech recognition module. Specifically, when a word of the original audio message 121 is distorted by the audio announcement device and is encountered as such in the announced audio message 131, several cases may arise:
The word has not been recognized by the speech recognition module and no word is therefore proposed in the reconstructed verbal content 151, or more precisely a sequence of appropriate symbols signals this lack of recognition, and the probability estimate for this word is zero.
Several candidate words may correspond to the portion in question of the announced audio message. The speech recognition module then proposes the one whose probability is highest. The difference between this probability and the value 1 corresponds to the risk that a listener might have of mistaking one word for another.
Lastly the word may have been correctly recognized by the speech recognition module, its probability of corresponding to the portion in question of the announced audio message being close to 1.

Thus by combining the probability estimates of each word, for example by averaging them in order to produce a resultant probability, a relevance indicator is obtained which will be commensurately closer to the value 1 as the words constituting the announced audio message 131 have properly been “understood” by the speech recognition module. It is then sufficient to compare this relevance indicator with a reference table, in order to derive therefrom a measure of the intelligibility level of the audio announcement device 40.

Advantageously, the calculation of this relevance indicator is carried out for significant fractions of the reconstructed verbal content 151 of the announced audio message, so as to take into account a minimum number of words. Thus, it is preferable to take into account a number of words corresponding to a message length of between 30 seconds and one minute, and more particularly to determine the values of the relevance indicator for lengths of 30 and 50 seconds.

In order to improve the measurement method described above, it is often useful to provide the speech recognition module with additional data. Examples which may be mentioned are to provide a dictionary of possible words, or alternatively training data generated by the speech recognition module itself following numerous speech recognition tests.

For example, when the original verbal content corresponds to a word list established according to the standard applicable to the phonetically balanced word list method, it is practical to limit the dictionary usable by the speech recognition module to this list of words. Faster and more precise recognition will thus be obtained.

The use of training data will be illustrated in relation to a second embodiment of the method according to the invention, in which embodiment the intelligibility measure is based on a comparison between the verbal content of the announced message reconstructed by the speech recognition module and the original verbal content.

FIG. 2a illustrates a first segment of the method for generating these training data.

In step 110 a predetermined original verbal content 111 is selected, and in step 120 the corresponding original audio message 121 is stored on a medium 122 then transmitted directly to the speech recognition step 150 without being “distorted” by the announcement step. The reconstructed verbal content of the original audio message is then transmitted to an analysis step 165, which may be an intrinsic analysis of the same type as step 160 seen above or, as will be seen in more detail below, an analysis by comparison with the original verbal content 111 obtained from step 110. These operations are repeated until the speech recognition of the original audio message 121 is complete, which is indicated by a 100% result. At this point the speech recognition module of step 150 has generated training data 152, which are capable of ensuring that the measurement of the intelligibility level would give an optimum result if the announced audio message 131 is not distorted by the audio announcement device 40.

In a second segment of the method, illustrated in FIG. 2b, the original audio message 121 obtained for example from the storage medium 122 is announced in step 130, and the announced audio message 131 is recorded in step 140 and transmitted to the speech recognition step 150. The speech recognition module receives the training data 152 obtained from the previous segment. Step 150 is thus improved, and the reconstructed verbal content 151 of the announced audio message 131 can be analyzed in a more refined fashion in step 160.

According to the second embodiment of the measurement method according to the invention, the original verbal content 111 defined in step 110 is introduced as a reference in this step 160, as indicated by the arrow in FIG. 2b. For this reason the analysis carried out is no longer exclusively intrinsic as seen above, but may also be conducted comparatively between the reference (original verbal content 111) and the verbal content 151 reconstructed from the announced audio message 131.

Other indicators for evaluating the correspondence between the two verbal contents may then be defined and used:
The recognition rate is defined as the number of words recognized correctly in relation to the total number of words,
The substitution rate is defined as the number of words substituted (erroneous) in relation to the total number of words,
The deletion rate is defined as the number of words deleted (missing) in relation to the total number of words,
The insertion rate is defined as the number of words wrongly inserted in relation to the total number of words,
The error rate is defined as the number of errors of any kind in relation to the total number of words. It will be understood that the error rate is equal to the sum of the substitution, deletion and insertion rates.
The accuracy rate is defined as the recognition rate minus the insertion rate.

Here again, for reasons of standardization and reproducibility of the measurement, it will be preferable to define these indicators for a predetermined message length, for example of between 30 seconds and one minute and more particularly for lengths of 30 and 50 seconds.

The intelligibility measure 170 of the audio announcement device 40, which is the result of the analysis in step 160, is then calculated by making a selection or forming a combination from the indicators above, for example by means of a linear combination, a root mean square or any other type of applicable formulation.

This way of analysis by comparison between the verbal content 151 of the announced message, reconstructed by the speech recognition, and the original verbal content 111 used in step 160 may be applied irrespective of the original verbal content, whether it consists of a list of words or phrases.

This second embodiment of the method may be improved further by synchronizing the verbal content 151 of the announced message, reconstructed by the speech recognition module, and the original verbal content 111.

To this end, in step 120, synchronization markers 125 are inserted into the original audio message 121 at predetermined locations of the original verbal content 111. For example, the synchronization marker 125 may be an audio signal such as a simple “bip” between each word of a word list or between each phrase in the modified rhyme method. The synchronization marker may also be more complex, the frequency or amplitude being modulated for example with a tone in order to form a long “bip” carrying richer information, such as a rank number of the phrase or of the following word. The synchronization marker 125 will be adapted so that is not deformed to the point of being unrecognizable when the original message is announced in step 130, for example by selecting a tone with a frequency which is easily detectable and generally retransmitted well by announcement devices, for example a tone of 2500 Hz.

The speech recognition of step 150 and/or the analysis of step 160 is performed in closed loop as a function of the positions of the synchronization markers 125 in the announced audio message 131. The verbal content of the announced message 151 may thus be synchronized with the original verbal content 111, and the comparison of the two may be carried out “word by word” thus making the comparison step faster and more precise.

For example the word of the n^{th} rank, as defined by the synchronization marker, obtained from the speech recognition module of step 150 is compared with the word with the same rank in the original verbal content 111. If the two words are identical, a counter is incremented. The ratio of the value of this counter to the number of words of the original verbal content, for a given length, is a possible measure of the intelligibility level of the announcement device. Since the speech recognition module does not have to analyze and compare the received audio fragment with all of its dictionary, but only with the candidate word identified by the synchronization marker, it can execute its task more precisely and more rapidly.

Reference will now be made to FIG. 3 in order to describe a preferred embodiment of the method, in the form of a third embodiment.

Steps 110 to 150 are identical to the steps with the same reference as described above. After step 120 of compiling the original audio message 121, however, it is transmitted to a new speech recognition step 155 identical in its operation to step 150. The speech recognition module of step 155 then reconstructs a reconstructed verbal content 112 of the original audio message 121. This content is then compared in step 160 with the reconstructed verbal content 151 of the announced audio message 131, in order to derive therefrom the indicators described above. A measure of the intelligibility level of the audio announcement device 40 is then calculated by making a selection or forming a combination from these indicators.

In this preferred embodiment, it is no longer necessary to impose a constraint on the original verbal content 111 of the original audio message. This is because, irrespective of this content, it will be reconstructed by the speech recognition module of step 155 in order to be compared with the reconstructed verbal content of the announced audio message 131.

Steps 150 and 155 may advantageously be carried out synchronously, and the comparison of step 160 may be carried out in real-time. Therefore, when there is an original audio message 121 in continuous stream being announced by the audio announcement device 40, the intelligibility level may be measured continuously, for example by calculating the combination of the indicators over a sliding period of the last 30 or 50 seconds.

This preferred embodiment is particularly advantageous because it makes it possible to measure the intelligibility level of an audio announcement device 40 in the presence of the public, without the latter being disturbed by this operation. In the methods of the prior art, conversely, and particularly with so-called objective methods, the stridence and the volume of the audio signals used makes measurement in the presence of the public impracticable or even impossible. However, the public per se are a variable to be taken into account because they greatly influence the background noise generated, the attenuation of certain frequencies and modification of the reverberations, for example. An empty train station or subway stop does not have the same acoustic properties as the same location when crowded as a train arrives, etc.

Now, by virtue of the method according to the invention, it is possible to envisage carrying out a measurement of the intelligibility level of the audio announcement device of a train station as a train arrives, when the ambient noise being generated will drown out certain frequencies or the presence of the train will modify the echo conditions, by continuously measuring the intelligibility level of an essentially verbal radiophonic broadcast or service messages, for example.

The measurement method according to the invention may also be used to tune an auditory prosthesis. Such a prosthesis is generally adjusted by the audiologist so that the audio amplification which it provides to the patient makes it possible to compensate for anomalies in the frequency response curve of their ear, as measured by the practitioner. This correction is not always satisfactory for the patient, however, who often complains of problems in understanding. This necessitates a procedure of tuning the prosthesis, involving the patient and the practitioner, which may prove to be a time-consuming and expensive procedure that is unpleasant for the patient. By placing a filter, representing the anomalies of the frequency response curve of the ear to be fitted with an aid, and the prosthesis in series, and by regarding this unit as the audio announcement device, it then becomes possible to measure the resulting intelligibility level for the patient by using the method of the invention.

FIG. 4 represents an apparatus 41 for measuring the intelligibility level according to the invention in the presence of an audio announcement device 40.

The audio announcement device 40 comprises, for example, an amplifier 401 and a plurality of loudspeakers 402. The amplifier 401 has an analog input 403 capable of receiving a signal representing an original audio message.

The measurement apparatus 41 comprises a microphone 411 adapted to be placed in the vicinity of one or more of the loudspeakers 402, in a position liable to be occupied by a listener. The microphone 411 is connected to a recording and digitization module 415, for example an analog-digital converter with which an audio recording card is equipped. This module delivers a signal representing the announced audio message 131 to a speech recognition module 418.

A reader 414 of storage media 420 and/or internal memories 416, such as a hard drive or a RAM or ROM memory etc., as well as a computer 412, are provided in order to manage the operation of the apparatus and to perform the calculations necessary for the measurement to be carried out. The apparatus also comprises a display 417 capable of displaying the results of the measurement.

Advantageously, all the instruction and data files for using the apparatus may thus be combined on a single storage medium, for example an optical disk or CD-ROM, or a memory card. Thus, it may for example contain the original audio message 121 in the form of an audio-type file such as an MP3 file, the original verbal content 111 of this message in the form of a text file, training data 152 relating to the message 121 for the speech recognition module 418, and program instructions in the form of files executable by the computer 412 in order to carry out the intelligibility measurement method.

The memory means 414, 416 are also adapted to provide an analog output module 413, for example a digital-analog converter, with digital information making it possible to compile a signal representing the original audio message 121.

The measurement apparatus 41 also comprises a synchronization signal generator 419 adapted to cooperate with the analog output module 413 and to insert synchronization markers 125 into the original audio message 121, at predefined locations of the original verbal content 111. In this case, the speech recognition module 418 is adapted to detect said markers and to synchronize the reconstructed verbal content of the announced audio message with the original verbal content.

The analog output module 413 is in turn connected to the analog input 403 of the amplifier 401, in order to transmit the signal representing the original audio message 121 to it.

The apparatus 41 operates according to the measurement method described above. On the basis of the data read from the CD-ROM 420 by the reader 414, or data contained in the internal memory means 416, the analog output module compiles the original audio message 121, optionally accompanied by synchronization markers 125, which is transmitted to the input 403 of the amplifier 401. This message is then announced by the loudspeakers 402 in the environment of the audio announcement device 40, for example a conference theater. The microphone 411 is placed in the vicinity of one or more of the loudspeakers 402, in a position liable to be occupied by a listener, at the place where the intelligibility level of the unit is intended to be measured. The announced audio message 131, recorded by the microphone 411 and processed by the recording and digitization module 415, is transmitted to the speech recognition module 418 which reconstructs its verbal content 151, optionally supplemented with an indication of the rank of the elements of its content as obtained by interpreting the synchronization markers 125 in the announced audio message. This verbal content 151 of the announced message is used by the computer 412, optionally together with the original verbal content 111 of the original audio message as read from the CD-ROM, in order to calculate the measure of the intelligibility level and display it on the display 417.

FIG. 5, in which elements identical to those in FIG. 4 bear identical references, also represents a measurement apparatus more particularly adapted for carrying out the measurement method according to its preferred embodiment. The measurement apparatus comprises a module 52 for compiling the original audio message, which is optionally detachable from the body of the apparatus and comprises a plurality of audio sources such as a microphone 521 or CD-ROM reader 522, or a speech synthesis module (not shown), selectively capable of providing the analog output module 413 continuously with an original audio message 121. This original audio message 121 is transmitted on the one hand to the audio announcement device 40, and on the other hand to a second recording and digitization module 515 then to a second speech recognition module 518. This second speech recognition module 518 provides the computer 412 with a reconstructed verbal content 112 of the original audio message 121, which allows the reconstructed verbal content 151 of the announced audio message 131 to be processed comparatively. The result of the comparison thus makes it possible, as seen above, to calculate a measure of the intelligibility level of the audio announcement device 40 and to display it by means of the display 417.

Of course, this description is given by way of illustration and the person skilled in the art may make numerous alterations to it without departing from the scope of the invention, for example replacing the analog signal between the apparatus 41 and the audio announcement device 40 by a digital link, optionally conveyed by an optical fiber, in order to minimize certain problems of interference and improve the transmission quality, or using a single speech recognition module by employing it sequentially, rather than using two of them in parallel.

Likewise, the measurement apparatus 41 may be formed by means of a suitably programmed personal computer, so long as it comprises elements such as a sound card adapted to record or emit audio messages with a sufficient quality.

1. A method for measuring the intelligibility level (170) of an audio announcement device (40), comprising the following steps:
defining (110) a verbal content of a voice message, referred to as the original verbal content (111),
compiling (120) an audio message, referred to as the original audio message (121), on the basis of said original verbal content,
announcing (130) said original audio message (121) using the audio announcement device (40),
recording (140) an announced audio message (131) at the output of the announcement device,
transmitting (150) said announced audio message (131) to a speech recognition module (418) adapted to reconstruct a verbal content (151) of the announced audio message (131),
analyzing (160) the verbal content (151) of the announced audio message reconstructed by the speech recognition module, and
calculating a measure of the intelligibility level (170) of the audio announcement device (40) on the basis of this analysis.

2. The measurement method as claimed in claim 1, wherein
in association with each word recognized in the announced message, the speech recognition module (418) is adapted to provide an estimate of the correspondence probability between said recognized word and a corresponding portion of the announced audio message,
the analysis of the verbal content of the announced message is carried out by calculating a relevance indicator on the basis of a resultant probability over at least a significant fraction of the verbal content of the announced message,
the measure of the intelligibility level is obtained by comparing said relevance indicator with a reference table.

3. The measurement method as claimed in claim 2, wherein the significant fraction of the verbal content of the announced message corresponds to a message length of between 30 and 50 seconds.

4. The measurement method as claimed in claim 1, wherein the analysis of the verbal content (151) of the announced message (121) is carried out by comparing it with the original verbal content (111).

5. The measurement method as claimed in claim 4, wherein synchronization markers (125) are inserted into the original audio message (121) at predefined locations of the original verbal content, and wherein the speech recognition is performed in closed loop as a function of the position of said synchronization markers in the announced audio message (131).

6. The measurement method as claimed in claim 1, wherein the original audio message (121) is a predetermined message, and wherein the speech recognition module is adapted by the addition of training data (152) relating to said original audio message.

7. The measurement method as claimed in claim 1, wherein the original audio message (121) is transmitted to a second speech recognition module (518) after the compilation step (120), and wherein the analysis of the verbal content (151) of the announced message (121) reconstructed by the first speech recognition module (418) is carried out by comparison with the verbal content (112) of the original audio message (121) reconstructed by the second speech recognition module (518).

8. The measurement method as claimed in claim 4, wherein the measure of the intelligibility level is obtained by a combination of indicators selected from among a recognition rate, a substitution rate, a deletion rate and an insertion rate, each indicator being calculated for a predetermined length of the original message.

9. The measurement method as claimed in claim 8, wherein the predetermined length corresponds to a message length of between 30 and 50 seconds.

10. The measurement method as claimed in claim 1, adapted for the tuning of an auditory prosthesis, wherein said auditory prosthesis is used as the audio announcement device (40) in series with a filter having a frequency response curve identical to that of an ear to be fitted with an aid, and wherein the intelligibility level of said device is measured.

11. An apparatus (41) for measuring the intelligibility level of an audio announcement device (40), which comprises:
at least one analog output (413) adapted to transmit an original audio message (121) to the audio announcement device (40),
at least one microphone (411) associated with a recording and digitization module (415) adapted to record an audio message announced (131) by said audio announcement device,
at least one speech recognition module (418) adapted to reconstruct a verbal content (151) of the announced audio message, on the basis of the announced audio message (131) recorded by the recording module (415),
a calculation module (412) adapted to analyze said verbal content (151) and to calculate a measure of the intelligibility level of the audio announcement device,
a display (417) adapted to visualize said measure.

12. The measurement apparatus (41) as claimed in claim 11, which furthermore comprises a reader (414) of storage media (420) and/or internal memory means (416) which is adapted to read and save files representing the original audio message, the verbal content of said message and training data of the speech recognition module.

13. The measurement apparatus as claimed in claim 11, which comprises a synchronization signal generator (419) adapted to cooperate with the analog output module (413) and to insert synchronization markers (125) into the original audio message (121) at predefined locations of the original verbal content (111), wherein the speech recognition module (418) is adapted to detect said markers and synchronize the reconstructed verbal content (151) of the announced audio message (131) with the original verbal content.

14. The measurement apparatus as claimed in claim 11, which furthermore comprises a module (52) for compiling the original audio message, which cooperates with the analog output module (413) in order to transmit an original audio message to the audio announcement device.

15. The measurement apparatus as claimed in claim 14, wherein the compilation module (52) for compiling the original audio message comprises at least one of a microphone (521), a storage medium reader (522) or a speech synthesis module.

16. The measurement apparatus as claimed in claim 11, which comprises a second recording and digitization module (515) as well as a second speech recognition module (518), which are adapted to cooperate with the analog output (413) and to reconstruct a reconstructed verbal content (112) of the original audio message (121), wherein the calculation module (412) is adapted to compare said reconstructed verbal content (112) of the original audio message and a verbal content (151) of the announced audio message, and to calculate a measure of the intelligibility level of the audio announcement device on the basis of said comparison.

17. A storage medium (420)—particularly of the removable type (CD-ROM, DVD, USB stick, memory card etc.)—for carrying out the measurement method as claimed in claim 1 with the aid of a data-processing device of the personal computer type, which medium contains at least a file of the audio type representing the original audio message, an associated file of the text type representing the verbal content of the original audio message and a file of training data, associated with the original audio message, for the speech recognition module.

18. The storage medium as claimed in claim 17, which furthermore contains program instructions adapted to program a speech recognition module (418; 518) and to carry out the calculation of the intelligibility measure.

19. The measurement apparatus as claimed in claim 12, which comprises a synchronization signal generator (419) adapted to cooperate with the analog output module (413) and to insert synchronization markers (125) into the original audio message (121) at predefined locations of the original verbal content (111), wherein the speech recognition module (418) is adapted to detect said markers and synchronize the reconstructed verbal content (151) of the announced audio message (131) with the original verbal content.

20. The measurement apparatus as claimed in claim 12, which furthermore comprises a module (52) for compiling the original audio message, which cooperates with the analog output module (413) in order to transmit an original audio message to the audio announcement device.
